(19) United States
(12) Patent Application Publication
(10) Pub. No.: US 2016/0075573 A1
(43) Pub. Date: Mar. 17, 2016

(54) METHODS FOR TREATING A FLUID CONTAMINATED WITH BACTERIA

(71) Applicant: BEN KAPLAN, Huntington Station, NY (US)

(72) Inventor: BEN KAPLAN, Huntington Station, NY (US)

(21) Appl. No.: 14/484,390

(22) Filed: Sep. 12, 2014

(51) Int. Cl. C02F 1/50

(52) U.S. Cl. CPC C02F 1/50; C02F 2303/04; C02F 2305/00

(57) ABSTRACT

The invention provides a method for treating a fluid contaminated with bacteria, the method comprising passing the fluid through a first filtration layer comprising a first membrane and an effective amount of capsaicin disposed adjacent said first membrane. Optionally, a second filtration layer may also be provided, the second filtration layer being disposed downstream of the first filtration layer, the second filtration layer comprising a second filtration membrane and an effective amount of activated carbon disposed adjacent the second membrane. The methods have particular application in treating water contaminated with the bacterium Escherichia coli.

### REFERENCE TO RELATED APPLICATIONS

This application claims the benefit under 35 U.S.C. §119(e) of prior co-pending U.S. Provisional Patent Application Ser. No. 61/877,960, filed Sep. 14, 2013.

### TECHNICAL FIELD

The present invention relates broadly to fluid filtration methods. More specifically, this invention relates to methods of filtering water to eliminate undesirable contamination from Escherichia coli (“E. coli”) and other bacteria having similar characteristics.

### BACKGROUND OF THE INVENTION

The contamination of a water supply with E. coli is a public health hazard for human beings, as it can cause serious (although not usually fatal) illness. The symptoms of an E. coli infection can include nausea, vomiting, stomach cramps, bloody diarrhea, and fever. Such infections are contagious, and can be spread from one person to another through fecal contamination.

The contamination of water supplies with E. coli can occur when human or animal feces containing E. coli find their way into lakes and streams, and humans can become infected when the water supply in a city or town or other municipality has not been properly treated. The E. coli bacteria can then be spread from person to person when an infected person fails to observe proper hygiene by washing his or her hands well after a bowel movement; the bacteria can spread from the infected person's hands not only to other people, but also to inanimate objects. The problem of contamination of water with E. coli and/or other, similar microbes can be especially prevalent in “third world” countries, but this problem can even occur within the United States where proper hygiene cannot be observed.

The most common treatment method is to add an anti-microbial agent such as chlorine to the water supply, in order to prevent E. coli contamination, or to eliminate it if it exists, or to reduce it to levels that are not harmful. However, chlorine is not always the best way to remove impurities from drinking water, because it can lead to the creation of trihalomethanes which can themselves cause health problems in humans, and therefore some communities are adverse to adding chemicals such as chlorine to their water supplies. Moreover, in recent years it has become popular to incorporate, particularly into household water supplies, filters which contain activated carbon, as a way of removing particulates and other impurities. However, such filters, by themselves, cannot eliminate contamination of the water supply by E. coli and/or other bacteria, and besides, it has also been shown that activated carbon filters to which bacteria are affixed cannot be disinfected using chlorine.

It is therefore the principal object of the present invention to provide a fluid filtration method which can effectively eliminate any contamination by E. coli or other bacteria that may exist in a water supply or other fluid supply, without the need for chlorination.

### SUMMARY OF THE INVENTION

This and other objects of the present invention are achieved by providing a filtration method for fluids such as water which includes passing the fluid though a filtration layer that comprises a first filtration membrane and an effective amount of capsaicin disposed adjacent the first filtration membrane. Optionally, the invention may also include passing the fluid through a second filtration layer which is situated downstream of the first layer, the second layer comprising a second filtration membrane and an effective amount of activated carbon disposed adjacent the second filtration membrane.

### BRIEF DESCRIPTION OF THE DRAWING

This and other aspects, features, objects and advantages of the present invention will become more apparent to those skilled in the art from the following detailed description of the presently most preferred embodiment thereof (which is given for the purposes of disclosure), when read in conjunction with the accompanying drawing (which forms a part of the specification, but which is not to be considered as limiting its scope), wherein:

FIG. 1 is a schematic view of a filtration arrangement which may be used to practice the methods of the present invention.

### DETAILED DESCRIPTION OF THE PREFERRED EMBODIMENT

The preferred embodiment of the present invention will now be further described. In the description below, the invention is described primarily with reference to a supply of water, but it is to be understood that the invention may also be used with fluid substances other than water.

It is well known that capsaicin, a spicy substance which occurs naturally in pepper plants, has very effective anti-microbial properties and can kill bacteria such as E. coli on contact. However, if capsaicin is added directly to a water supply, the result is decontaminated water which will have a “spicy” taste. This problem is eliminated with the present invention, which in a preferred embodiment provides a first filtration membrane that either supports or is disposed adjacent to an effective amount of capsaicin in crystalline form; the first filtration membrane effectively prevents the capsaicin from migrating downstream in the water supply and imparting a “spicy” taste to the water.

As a “safety,” however, the present invention optionally, and more preferably, includes a second filtration membrane situated downstream of the first membrane, the second membrane either supporting or disposed adjacent to an effective amount of activated carbon. The activated carbon removes from the water supply any capsaicin which may have passed through the first filtration membrane. Thus, the present invention utilizes capsaicin to eliminate E. coli or other bacteria from a water supply, and utilizes a substance commonly found in household water filters, namely, activated carbon, to remove any capsaicin that may remain in that water supply.

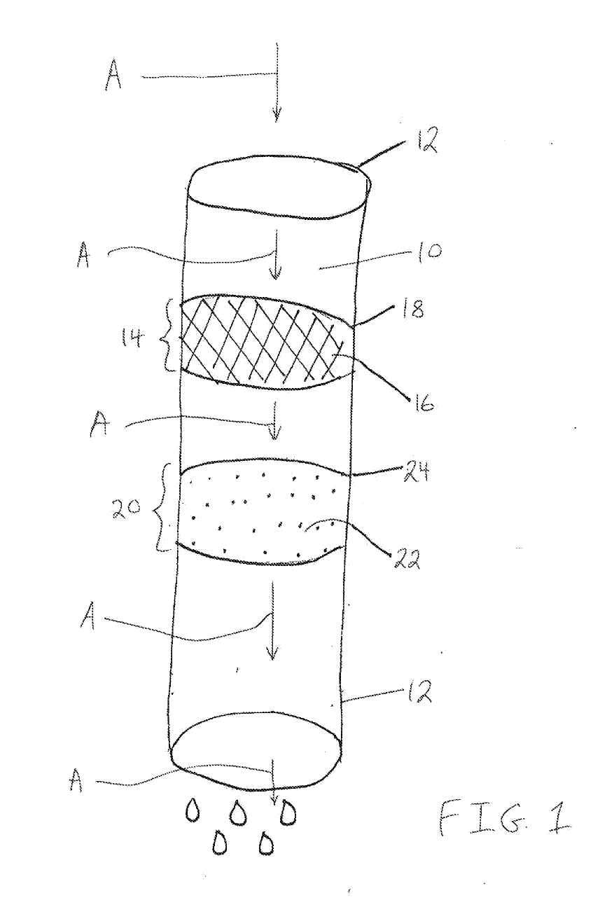

Referring now to FIG. 1 of the drawings, which illustrates schematically how the methods of the invention may be practiced, a water stream 10 is shown flowing through a pipe or other conduit 12 in the direction of arrows A. A first fluid filtration layer 14 is situated within the water stream 10, spanning substantially the entire width or diameter of conduit 12. First fluid filtration layer 14 comprises an effective amount of capsaicin 16, disposed adjacent a first filtration membrane 18.

Optionally, a second fluid filtration layer 20 is also situated within the water stream 10, also spanning substantially the entire width or diameter of conduit 12. Second fluid filtration layer 20 is situated downstream of first fluid filtration layer 14, and comprises an effective amount of activated carbon 22, disposed adjacent a second filtration membrane 24.

In experimental tests conducted by the inventor, ordinary household cheesecloth was used both for first filtration membrane 18 and for second filtration membrane 24. However, it is to be understood that any appropriate material may be used, as long as it is porous to water flow but will prevent migration of the capsaicin 16 or the activated carbon 22, respectively, in the direction of the water flow. It should be understood also that the material chosen for first filtration membrane 18 and for second filtration membrane 24 should be strong enough to support the capsaicin 16 and the activated carbon 22, respectively, not only against the flow of water, but also against the pull of gravity, in the event that conduit 12 is oriented vertically, as shown in FIG. 1.

For use with the present invention, it is preferred that the capsaicin 16 be in crystalline form, which is available commercially and which may be obtained from a variety of sources, including The Carolina Sauce Company, Inc., of Durham, N.C. However, capsaicin may also be extracted from the seeds of chili peppers in situ using alcohol, which results in a capsaicin powder that is an acceptable crystalline form for use with the present invention. Activated carbon 22 for use with the present invention is also available commercially from a wide variety of sources, including Carolina Science Supply of Burlington, N.C.

It has been found that an effective amount of capsaicin 16, for the purposes of this invention, is an amount which substantially covers first filtration membrane 18 across the entire width or diameter of conduit 12, such that virtually the entire water stream 10 must come in contact with the capsaicin 16 just prior to flowing through first filtration membrane 18. Similarly, it has been found that an effective amount of activated carbon 22, for the purposes of this invention, is an amount which substantially covers second filtration membrane 24 across the entire width or diameter of conduit 12, such that virtually the entire water stream 10 must come in contact with the activated carbon 22 just prior to flowing through second filtration membrane 24.

Capsaicin is an organic molecule, methyl vanillyl nonemide (8-methyl-N-vanillyl-6-nonenamide), which occurs naturally in chili peppers, that is, in many (but not all) of the plant species belonging to the genus Capsicum. Capsaicin is lethal for E. coli; the mechanism by which capsaicin acts in this regard appears to be related to the potency of capsaicin to effect changes in the fluidity of the bacterial cell membrane. Capsaicin is also a hydrophobic molecule, and therefore it will not dissolve in, and is in fact repelled by, water. Accordingly, it is expected that any filtration devices with which the methods of the present invention may be practiced will be usable for long periods of time, and/or can be re-used, without requiring replacement.

Those skilled in the art will be aware that capsaicin is an irritant for human beings, causing a burning sensation in any tissue with which it comes in contact, and that it can damage human skin. Therefore, the methods of the present invention must be practiced with an understanding that measures must be taken to ensure that the capsaicin is securely contained.

The methods of the present invention may be practiced by constructing filters which contain capsaicin and, optionally, activated carbon, as described above. Alternatively, capsaicin may be added to existing, commercially available reverse-osmosis filters, as well as to commercially available activated carbon water filters, in order to enhance the performance of such filters. In either case, practicing the method in accordance with the invention allows the chemical properties of capsaicin to ensure the death of all E. coli bacteria in any water that comes in contact with the capsaicin.

In experiments performed by the inventor in order to test the efficacy of the inventive methods, it was found that capsaicin was able to eliminate all traces of E. coli in contaminated water samples quite quickly, that is, in the time it took for water to flow through an experimental filtration device constructed as described above. Moreover, there were no traces of capsaicin in the water sample following decontamination.

In these experiments, a charge of water intentionally contaminated with E. coli was first passed through a layer of capsaicin resting on cheesecloth and then passed through a layer of activated carbon resting on a separate cheesecloth (plates 3A, 3B and 3C). Two controls were also used: one in which the intentionally contaminated water was not filtered at all, as a positive control (plates 2A, 2B and 2C) and one in which non-contaminated water was used, as a negative control (plates 1A, 1B and 1C).

In each case, the resulting charge of water was then passed through an additional filter, for detection purposes only. Since E. coli bacteria are approximately 0.5 microns in size, the additional filter was chosen to have a pore size of about 0.45 microns, in order to insure that any E. coli bacteria remaining in a given sample would be held on the filter for subsequent transfer to a petri dish containing an appropriate nutrient broth, followed by incubation. A colony count was conducted prior to incubation, and then once daily for five days after incubation. The results are given in Table 1 below.

TABLE 1

| Plate | | | | | |
|---|---|---|---|---|---|
| Identifi- | Day | Day | Day | Day | Day |
| cation | 1 | 2 | 3 | 4 | 5 |
| 1A | 0 | 0 | 0 | 0 | 0 |
| 1B | 0 | 0 | 0 | 0 | 0 |
| 1C | 0 | 0 | 0 | 0 | 0 |
| Aver- | 0 | 0 | 0 | 0 | 0 |
| age: | | | | | |
| 2A | 1 | 2 | 2 | 2 | 2 |
| 2B | 0 | 1 | 2 | 2 | 2 |
| 2C | 2 | 1 | 0 | 0 | 0 |
| Aver- | 1 | 1.333333333 | 1.333333333 | 1.333333333 | 1.333333333 |
| age: | | | | | |
| 3A | 0 | 0 | 0 | 0 | 0 |
| 3B | 0 | 0 | 0 | 0 | 0 |
| 3C | 0 | 0 | 0 | 0 | 0 |
| | | | Average | | |
| | | | E. Coli | | |
| | | | growth | | |
| Experi- | 0 | 0 | 0 | 0 | 0 |
| mental | | | | | |
| Nega- | 0 | 0 | 0 | 0 | 0 |
| tive | | | | | |
| Control | | | | | |
| (Water) | | | | | |
| Posi- | 1 | 1.33333 | 1.333333 | 1.33333 | 1.333333 |
| tive | | | | | |
| Control | | | | | |
| (E. coli) | | | | | |

The data in Table 1 show that one or two E. coli colonies appeared on each of the plates in the positive control, confirming the expected bacterial growth in water that had not flowed through the capsaicin. The data also show, as expected, no bacterial growth on each of the plates in the negative control. However, and most importantly, on the plates where the E. coli had come in contact with capsaicin no visible bacterial colonies appeared.

It is believed that the methods of the present invention can be used to decontaminate the water supply in geographic locations where the water quality is generally poor and commonly causes illness in humans, such as in third world countries, and can thereby improve the health of the populations in such countries. In addition, in the U.S. the methods of the present invention have applicability in homes, restaurants, and in other locations. Moreover, portable versions can be used by tourists, and recreational use on very short notice is also possible, for example on camping trips, where potable water supplies may be low, thereby eliminating the risk of cooling with, or drinking directly from, a possibly-contaminated natural water source such as a lake or pond.

While the methods of the present invention have been illustrated above primarily with respect to contamination by a particular bacterium, namely, E. coli, it is expected that the methods of the present invention may be used for decontamination of fluids contaminated with other bacteria having similar characteristics. Furthermore, while it is also expected that the methods of the present invention may be used for decontamination of fluids other than water, it should be understood at the same time that these methods cannot be used with fluids such as alcohol or glycerine, as capsaicin is soluble in such fluids and would dissolve without having much of an anti-proliferative effect on E. coli bacteria. Similarly, although it is expected that changes in temperature of the water supply should not affect the ability of capsaicin to kill E. coli bacteria on contact, the melting point of capsaicin is 65 degrees C. (149 degrees F.), and therefore it would not be advisable to practice the methods of the present invention in a dishwasher, as the water temperature in most dishwashers exceeds 65 degrees C. which would cause the crystalline capsaicin to melt, and allow it to mix with the water and pass through the filter. However, those skilled in the art will be aware that filtration at any temperature above about 48 degrees C. would be pointless in any event, since most bacteria cannot survive at such temperatures.

While there has been described what are at present considered to be the preferred embodiments of the present invention, it will be apparent to those skilled in the art that the embodiments described herein are by way of illustration and not of limitation. Various modifications of the disclosed embodiments, as well as alternative embodiments of the invention, will become apparent to persons skilled in the art upon reference to the description of the invention. Therefore, it is to be understood that various changes and modifications may be made in the embodiments disclosed herein without departing from the true spirit and scope of the present invention, as set forth in the appended claims, and it is contemplated that the appended claims will cover any such modifications or embodiments.

1. A method for treating a fluid contaminated with bacteria, the method comprising (a) providing a first filtration layer comprising a first membrane and an effective amount of capsaicin disposed adjacent said first membrane, and (b) passing said fluid through said first filtration layer.

2. The method of claim 1 wherein said bacteria comprise bacteria of the species Escherichia coli.

3. The method of claim 2 further comprising the step of providing a second filtration layer comprising a second membrane and an effective amount of activated carbon adjacent to said second membrane, and passing said fluid through said second filtration layer after said fluid passes through said first filtration layer.

4. The method of claim 3 wherein said fluid is water.

5. A method of decontaminating a fluid having unacceptable levels of bacterial contamination, the method comprising (a) providing a first filtration layer comprising a first membrane and an effective amount of capsaicin disposed adjacent said first membrane, and (b) passing the water through said first filtration layer.

6. The method of claim 5 wherein said bacterial contamination is contamination with Escherichia coli.

7. The method of claim 6 further comprising the steps of providing a second filtration layer comprising a second membrane and an effective amount of activated carbon disposed adjacent said second membrane, and passing said fluid through said second filtration layer after said fluid passes through said first filtration layer.

8. The method of claim 7 wherein said fluid is water.

9. A method of filtering a stream of water, the method comprising coupling the water stream to a first filtration layer comprising a first membrane and an effective amount of capsaicin disposed adjacent said first membrane.

10. The method of claim 9 further comprising coupling the water stream to a second filtration layer comprising a second membrane and an effective amount of activated carbon disposed adjacent said second membrane, said second filtration layer being situated downstream of said first filtration layer.
